(19) United States
(12) Patent Application Publication
(10) Pub. No.: US 2015/0007223 A1
(43) Pub. Date: Jan. 1, 2015

(54) PROCESS AND DEVICE FOR COMMUNICATING BETWEEN TERMINALS

(71) Applicants: Alain Molinie, Montpellier (FR); Eric Lavigne, Montpellier (FR); Vincent Leclaire, Montpellier (FR)

(72) Inventors: Alain Molinie, Montpellier (FR); Eric Lavigne, Montpellier (FR); Vincent Leclaire, Montpellier (FR)

(73) Assignee: AWOX, Montpellier (FR)

(21) Appl. No.: 14/365,712

(22) PCT Filed: Dec. 17, 2012
(86) PCT No.: PCT/FR2012/052960

§ 371 Date: Jun. 16, 2014

(30) Foreign Application Priority Data
Dec. 16, 2011 (FR) 1161813

(51) Int. Cl. H04N 21/436; H04N 21/43; H04N 21/643; H04N 21/41; H04N 21/4722

(52) U.S. Cl. CPC H04N 21/43615; H04N 21/4126; H04N 21/4722; H04N 21/64322; H04N 21/4307
USPC 725/37

(57) ABSTRACT

The method of communication between terminals includes:
a step of discovery between the terminals (13, 16),
a step of broadcasting by one of the terminals, termed the “first” terminal (13), a televisual programme,
a step of displaying, by the first terminal, an item of information representative of a first additional stream associated with the televisual programme,
a step of transmitting, by the first terminal to a second terminal, an item of information representative of a second additional stream associated with the televisual programme,
a step of access to a remote application, by the second terminal (16) and
a step of displaying by the second terminal, in a user interface of the application, messages representative of the second additional stream. Preferably, during the transmission step, the item of information representative of the second additional stream is emitted on a multipoint network.

### RELATED APPLICATIONS

This application is a §371 application from PCT/FR2012/052960 filed Dec. 17, 2012, which claims priority from French Patent Application No. 1161813 filed December, 2011, each of which is herein incorporated by reference in its entirety.

### TECHNICAL FIELD OF INVENTION

The present invention relates to a method and a device for communicating between terminals. It applies, in particular, to communication between a television, a portable electronic device and a remote computer system, e.g. a televisual programs server.

### BACKGROUND OF THE INVENTION

Traditionally, broadcasting televisual programs has been performed by transmitting a unidirectional signal from one source to a plurality of televisions. For example, this broadcasting is carried out by a terrestrial or satellite radio channel, or by means of a cable.

DVB-T (Digital Video Broadcasting-Terrestrial) is a digital television transmission standard using terrestrial radio links. DVB-T defines the transmission method of television services (audio, video and data). This standard takes into account the characteristics of radio transmission, particularly in terms of low available bandwidth, by strong attenuation at the location of the receptor, signal-to-noise ratio limitation, interference between adjacent channels and intersymbols linked to long multipath travel and the presence of impulse noise. The possible presence of strong echoes due to poor reception conditions (aerials not in the clear, etc.) imposes COFDM.

The DVB-T standard makes it possible to implement synchronous isofrequency networks, and to save frequencies by using the same frequency for emitters covering adjacent areas. This network principle requires perfect synchronization of time and frequency of all the emitters in the network and is completely transparent to the receiver.

Although this standard makes it possible to transmit signals encoded according to the MPEG 4 standard and additional information, such as the channel's television guide, the services it authorizes are very limited.

HbbTV (“Hybrid Broadcast Broadband TV”) is both an industry standard and an initiative to promote the harmonization of television broadcasting and internet access in the provision of programs to end consumers through connected televisions and “set-top boxes”, home terminals connected to dedicated cables or to the telephone network. The HbbTV specifications were approved on Jul. 1, 2010 under reference ETSI TS 102 7962.

HbbTV aims to make it possible for consumers to access new services from suppliers of shows and other entertainment, e.g. video-on-demand (“VOD”), interactive advertisements, customization, votes, interactive games and social networking functions. HbbTV makes it possible to access services over the Internet.

“IP television”, or “TVoIP”, or “IPTV” (Internet Protocol Television) is a form of television broadcast over a network using the IP (Internet Protocol). The term IPTV covers live television, video on demand and “Catch-up TV” sessions. There are various communications methods. Live television uses a multicast IP solution, which allows information to be sent just once for several people. VOD and Catch-up TV use an IP unicast solution (only one destination for these streams.) It uses the same infrastructure as Internet access, except it has a reserved bandwidth.

Since the audio stream is digital, the broadcast protocols are part of the IP-compatible broadcast protocols such as Digital Video Broadcasting (DVB), Digital Audio Broadcasting (DAB) and streaming. Video on demand (VOD) is based on the Real Time Streaming Protocol (RTSP) while TV is based on version 2 of the Internet Group Management Protocol (IGMP).

IP technology makes it possible to share the interface with other applications (Internet, VOIP). Moreover, more and more efficient codecs (MPEG-2, MPEG-4 and VC-1) make it possible to reduce bandwidth utilization. Thanks to multicasting, only the channels being watched are sent over the IP network, unlike VOD where the video content is sent in unicast and therefore the bandwidth is used for each viewer.

IPTV services announced or already available comprise:
more high definition (HD) channels;
stereoscopic 3D channels;
HD and 3D video on demand (VOD);
event-specific channels; and
channel supplement channels: the viewer can select the angle of view (e.g.: ability to follow a car, in particular during a Formula 1 Grand Prix race).

For content broadcasters (television channel, radio program), providing information related to a program broadcast on a receiver (television, radio) requires implementing a specific application interacting with the infrastructure through the network. Currently, this application is unable to interact directly with the broadcast on the television or the radio other than by time synchronization. However, this time synchronization remains difficult, depending on whether the broadcast is carried out by satellite, terrestrial emitters, or over the Internet.

In recent years, a large number of receivers (television, decoder, radio) have been fitted with an Ethernet and/or Wi-Fi connection. Most of these receivers implement the UPnP/DLNA, or Bonjour standard and/or some other discovery protocol, to search for content over the network (“player” function) or to receive content from a device (“renderer” function). The renderer function of a receiver allows another device on the network to take control of the receivers screen to launch content (“controller” function).

Moreover, content broadcasters are moving towards the broadcasting of content and also of applications related to the content on these same receivers. In this way, the Freeview standard in the United Kingdom transmits applications that allow users to interact with their receiver through a red button on the remote control when a banner appears on the screen. This interaction can consist of receiving further information, launching a game program, etc.

These applications are, however, specific.

Document US 2008/208839 is known, wherein a secondary device through which a user must query a main appliance to find additional data that may be available. This system therefore doesn't make an augmented television possible, i.e. a television that continuously displays an indicator of available additional data to the user.

### OBJECT AND SUMMARY OF THE INVENTION

The present invention aims to remedy all or part of these drawbacks. To this end, according to a first aspect, the present invention envisages a method for communicating between terminals that comprises:
a step of discovery between the terminals (13, 16),
a step of broadcasting a televisual program by one of the terminals, called the “first” terminal (13),
a step of displaying, by said first terminal, an item of information representative of a first additional stream associated with said televisual program,
a step of transmitting, by the first terminal to a second terminal, an item of information representative of a second additional stream associated with said televisual program,
a step of accessing a remote application, by the second terminal, and
a step of displaying by said second terminal, within a user interface of said application, messages representative of the second additional stream.

Thanks to these provisions, an application can be broadcast on the receiver and provide a user interface that can be broadcast over the network, in particular a home network, to all of the connected devices (Smartphones, tablets) to provide a genuine synchronous multi-screen interface. Because it is the first terminal, a television for example, that sends the information representative of the additional stream, there is no need for the second terminal, e.g. a tablet or Smartphone, to send any request to ascertain the presence of this additional stream.

In embodiments, during the transmission step, the item of information representative of the second additional stream is emitted over a multipoint network.

In embodiments, the method that is the subject of the present invention also comprises, after the step of displaying messages representative of the second additional stream in a user interface of the application, a step of taking control of the first terminal by a second terminal.

In embodiments, the second terminal utilizes a UPnP client/server Remote User Interface (RUI) to send commands over a network linking the first and the second terminal.

In embodiments, the method that is the subject of the present invention comprises:
a step of broadcasting, by means of a system for broadcasting from one point to several points, said application comprising a server of pages described with a hypertext markup language,
a step of receiving said pages by the second terminal,
a step of accessing, by the second terminal, graphical resources and/or pointers to graphics resources linked to said pages, by means of an internet link of the second terminal, and
a step of synchronizing, by said application, audiovisual programs broadcast by the broadcast system and data accessed over the Internet by said second terminal.

In embodiments:
during a signaling step, an application announces its presence on the network using UPnP/DLNA or Bonjour types of technologies and/or some other discovery protocol and/or
the second terminal discovers the page server by utilizing UPnP/DLNA or Bonjour types of technologies and/or some other discovery protocol.

In embodiments, the pages are described in HTML and the receiver comprises an HTML display unit.

In embodiments, during an interaction step, at least one other device connected to the network interacts with the receiver, by means of a renderer function of the receiver.

In embodiments, during an interaction step, at least one other device connected to the network interacts with the receiver, by means of a remote user interface's renderer function.

According to a second aspect, the present invention envisages a device for communicating between terminals, characterized in that it comprises:
a means of discovery between the terminals,
a means of broadcasting a televisual program by one of the terminals, called the “first” terminal,
a means of displaying, by said first terminal, an item of information representative of a first additional stream associated with said televisual program,
a means of transmitting, by the first terminal to a second terminal, an item of information representative of a second additional stream associated with said televisual program,
a means of access to a remote application, by the second terminal and
a means of displaying by the said second terminal, in a user interface of said application, messages representative of the second additional stream.

In embodiments, the means of transmission emits the item of information representative of the second additional stream over a multipoint network.

In embodiments, the device that is the subject of the present invention comprises:
a means of broadcasting, by means of a multipoint network, an application comprising a server of pages described with a hypertext markup language,
a means of receiving and displaying said pages by the receiver,
a means of accessing graphical resources and/or pointers to graphics resources linked to said pages, by means of an internet link of the receiver, and
a means of synchronizing, by said application, audiovisual programs broadcast by the broadcast system and data accessed over the Internet by said second terminal.

According to a third aspect, this invention envisages a device for communicating between terminals that comprises:
a means of discovery between the terminals,
a means of broadcasting a televisual program by one of the terminals, called the “first” terminal,
a step of displaying, by said first terminal, an item of information representative of an additional stream associated with said televisual program,
a means of access to a remote application, by second terminal,
a means of displaying a user interface of said application by said second terminal, and
a means of taking control of a first terminal by a second terminal.

According to a fourth aspect, the present invention envisages device for communicating between terminals that comprises:
a means of broadcasting, by means of a system for broadcasting from one point to several points, an application comprising a server of pages described with a hypertext markup language,
a means of receiving said pages by the receiver,
a means of accessing graphical resources and/or pointers to graphics resources linked to said pages, by means of an internet link of the receiver, and
a means of synchronizing, by said application, audiovisual programs broadcast by the broadcast system and data accessed over the Internet by said second terminal.

As the particular features, advantages and aims of these devices are similar to those of the method that is the subject of the present invention, they are not repeated here.

### BRIEF DESCRIPTION OF THE DRAWINGS

Other advantages, aims and particular features of the present invention will become apparent from the description that will follow, made, as a non-limiting example, with reference to the drawings included in an appendix, wherein:

FIG. 1 represents, schematically, a particular embodiment of the device that is the subject of the present invention, its environment and the communications links between its components,

FIG. 2 represents, in the form of a logical diagram, steps utilized in a particular embodiment of the method that is the subject of this invention, and

FIGS. 3 and 4 represent, schematically, display screens for implementing the present invention.

### DETAILED DESCRIPTION OF EMBODIMENTS

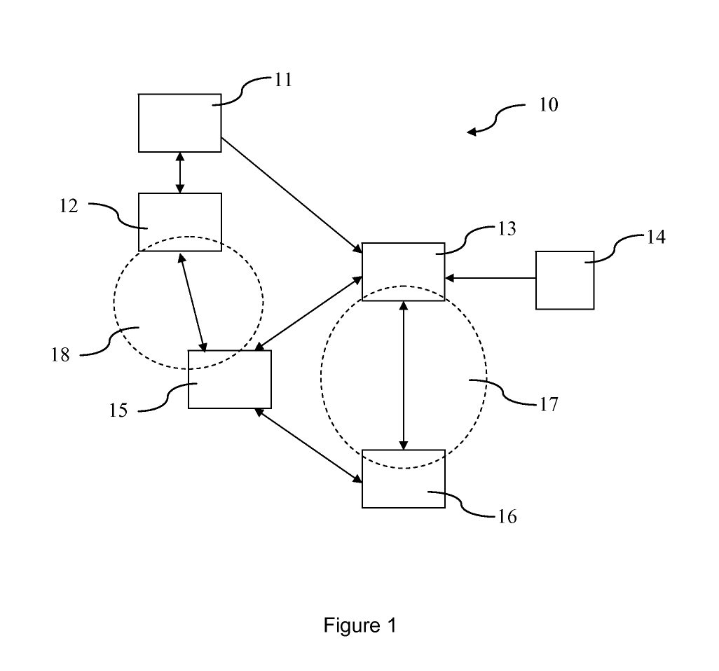

FIG. 1 shows a televisual programs emitter 11 connected to an additional content server 12. A television 13 receives the audiovisual programs emitted by the emitter 11, for example via a built-in decoder (not shown). When it is active, the television 13 displays, under the control of a remote control 14, at least one of the televisual programs received. A home network 17 connects the television 13 to a portable communicating electronic device 16.

The home network 17 utilizes, for example, the DLNA standard, as detailed below.

The portable communicating electronic device 16 is, for example, a tablet or a Smartphone.

The television 13 and the electronic device 16 communicate, preferably by means of a multipoint link. For example, this multipoint link utilizes the Wi-Fi standard. The home network utilizing this multipoint link may comprise an internet terminal 15, or “set-top box”. The set-top box 15 is connected to an Internet network 18 and may, in particular, access the server 12. It should be noted, however, that it is not essential for the home network to comprise the set-top box 15. For example, the television 13 may have the means, embedded, and implement the steps of the device and of the method that are the subject of the present invention without the set-top box 15 being present.

At least one televisual program 11 comprises:
a principal stream representing at least images and sounds; and
an additional stream representing the availability of data or computer applications additional to the principal stream.

For example, the additional stream indicates the availability of additional points of view (e.g. from other cameras at a sports event), of on-demand programs (e.g. the full-length version of a movie being broadcast in its short version) or electronic addresses where information relating to the program being watched can be found (e.g., URL ‘uniform resource locator’ addresses of manufacturers or retailers of a product for which an advertisement is being broadcast, or of games broadcasters). In all cases, the additional stream allows the formation of an additional image on a screen of the electronic device 16.

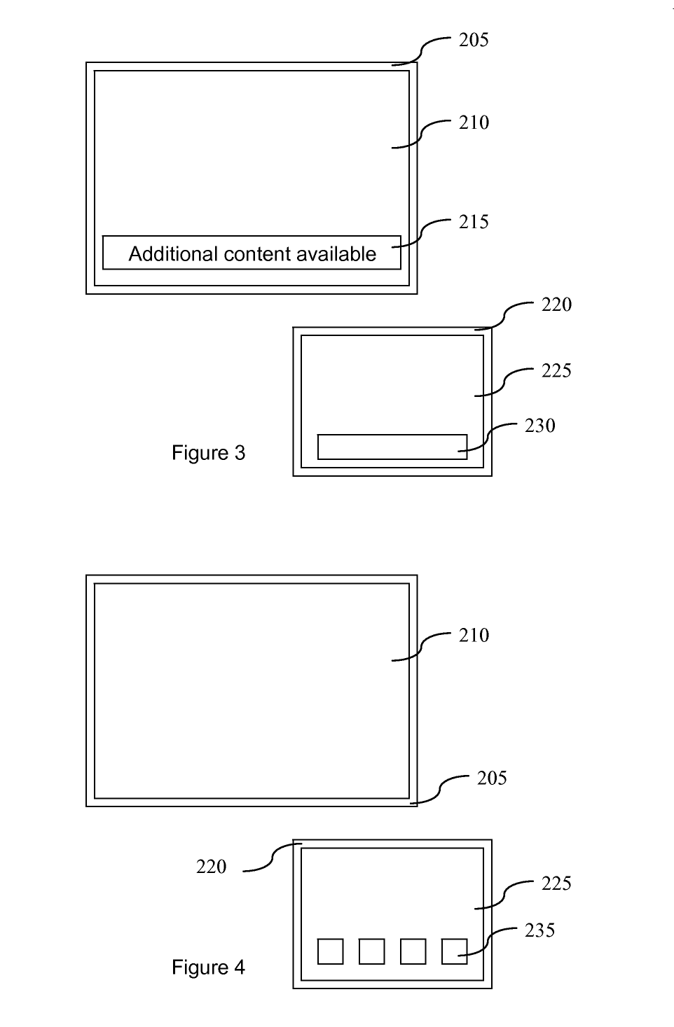

The television 13 is designed to communicate, over the home network's multipoint link 17, a message representative of the televisual program primarily displayed on its screen and of the additional stream. The television 13 is also designed to display, on its display screen, a message indicating the presence of a stream additional to the televisual program being displayed, as shown in FIG. 3.

For example, the television 13 sends a message indicating:
the channel being watched: 23 and
the URL to consult: http://www.awox.channel23.html.

At the user's command, the electronic device 16 displays the data coming from the additional stream and accesses the content available on the server 12 related to the program displayed on the television's screen 13.

Depending on the renderer selected (as defined by the DLNA standard) by means of the electronic device 16, the data received from the server 12 via the Internet 18 and possibly from the set-top box 15 are displayed on the screen of the electronic device 16 and/or of the television 13.

For example, the electronic device 16 functions as a user interface, in particular as keyboard and touch screen for a dual display screen game or program. It should be noted that the televisual program originally displayed by the television 13 can no longer be displayed or be displayed as a thumbnail or as “picture in picture”.

In other modes of operation, the electronic device 16 makes it possible to continue to consult and/or interact with the server 12 while the television 13 is used to display a televisual program other than that originally broadcast.

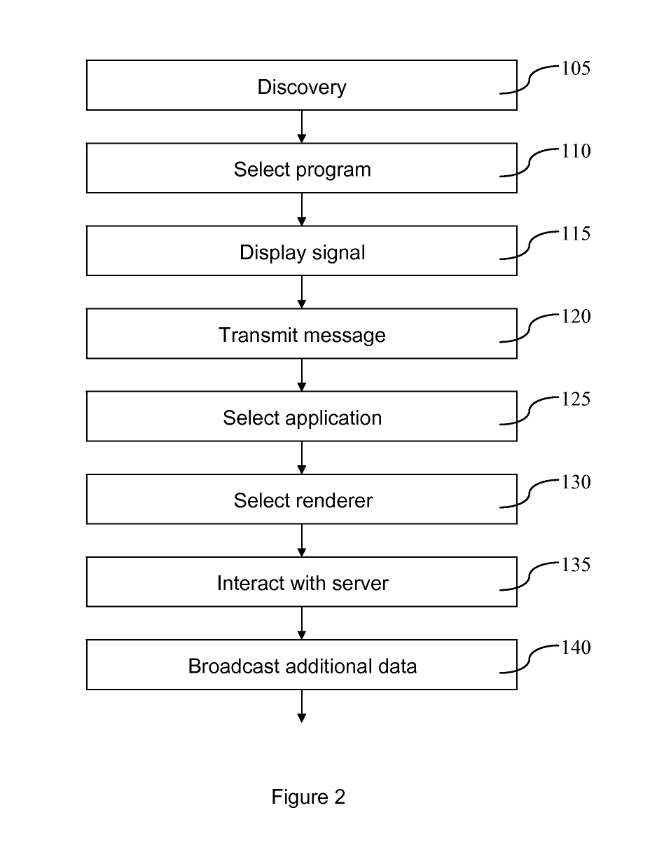

As shown in FIG. 2, the implementation of the method that is the subject of the present invention may comprise, firstly, a discovery phase 105, as defined in the DLNA standard, each declaring device obtaining information as to the capabilities of the other devices present on the network. These devices are then classed into four types:
the “server”, which holds the digital content and supplies same, on request;
the “renderer”, which decodes the digital content so that it can be played;
the “player”, which plays the decoded content; and
the “controller” (“control point”), which makes it possible to browse through the content proposed by the servers and have it played by the renderers/players.

Then, during a step 110, the user performs a selection of a broadcast televisual program, in particular by utilizing a remote control 14.

During a step 115, the television 13 displays the televisual program and a signal indicating the presence of an additional stream.

During a step 120, the television 13 emits a message over the multipoint link towards the other devices present on the home network to indicate the televisual program being broadcast and the additional content stream.

During a step 125, the user selects an application with the electronic device 16 and accesses this application on a server, for example the server 12. The electronic device 160 then takes control of the television 13 if the latter authorizes it to.

During a step 130, a user interface of the application appears on the electronic device 16 and the user chooses a renderer for at least part of the content of the application, for example the television 13 and/or the electronic device 16.

During a step 135, the user interacts with the application on the server 12 by utilizing the electronic device 16.

During a step 140, the user can make the television 13 display additional data, for example, an image taken by a camera with an angle of view different from that used in the televisual program being displayed on the screen of the television 13.

FIG. 3 shows a television 205 and an electronic device 220 at the beginning of the broadcast of a televisual program by the television 205. The television 205 comprises a display screen 210 on which appears a visual marker 215 indicating the presence of additional data. At the same time, if it is configured to do so, the electronic device 220, which comprises a display screen 225, receives from the television an item of information indicating the presence of additional content and displays the same marker, now under reference 230. This marker 230 can be selected by the user, e.g. by means of a touch screen, to access additional data available on the Internet.

When the user has confirmed this access, as shown in FIG. 4, an application displays a graphical user interface (“GUI”) on the electronic device 220. For example, this graphical interface comprises selection buttons 235. For example, these buttons make it possible to play or select available views other than that displayed on the television 205.

In this way, the user commands adding to the televisual program an application in overlay mode provided by the portable device 16, by displaying this application's user interface on the screen of the television 13 or on the electronic device 16 communicating with the television.

Preferably, an interface described in HTML is chosen, in particular to choose its positioning on the screen, and a URL electronic address for reading an HTTP (hypertext transfer protocol) link or accessing an internal resource.

There is thus an output from the television 13 towards the external device 16, such as a tablet, a Smartphone or a personal computer, for example connected to the set-top box 15. For example, personalized information is transmitted (e.g. cancelling a show).

The problem of synchronization between the television 13 and the device 16 external to the television is solved, particularly as regards the channel displayed on the television, by utilizing an open standard that makes it possible to discover a device on the home network, for example one of the DLNA and CEA 2014 standards.

After the discovery of the devices, messages are communicated to same. For example, “would you like to play?”, “do you want to display another camera?” or “would you like to see the full-length version?”. The different message types depend on what is displayed on the screen of the television 13. The external device 16 thus takes control of the television 13 if the latter authorizes it to.

In this way, an application is broadcast on the television 13, by proposing a user interface that can be broadcast over the home network's multipoint link to all of the connected devices (Smartphones, tablets), that provides a genuine synchronous multi-screen interface.

In embodiments, the system consists of:
an application downloaded via the broadcast system (via satellite, via the Internet, via aerial emitter, etc.) using technology similar to Freeview, HbbTV, MHP, or others. This application consists of a server of HTML pages, which HTML pages can be retrieved from the receiver, of graphic resources and/or pointers to associated graphical resources retrievable via the receiver's Internet link. This application announces its presence on the network using UPnP/DLNA or Bonjour types of technologies and/or some other discovery protocol;
the connected devices can discover these servers thanks to UPnP/DLNA or Bonjour types of technologies and/or some other discovery protocol, and play them thanks to an HTML display. Because it is located on the receiver, the application can handle synchronization between the program being broadcast and the host screen, and
the connected devices can interact with the screen in return, either through the receivers renderer function, or through a remote user interface's renderer function.

Functional elements are included on the server 12. Thus, instead of only serving media, a part of the server 12 performs an action. In other words, an element of the UPnP tree's CDS provided by a media server is in fact an operation on one or more media items, which can be selected either implicitly, or explicitly at a later time. This concept is similar to those of Software as a Service (SaaS) providing the application over the Internet instead of requiring the application to be present on the client.

It should be noted that the DLNA standard defines an interoperability standard allowing playing, sharing and control of multimedia devices regardless of their brand or type. Often, player, renderer and controller are in a single device, which can be likened to the client in the client/server model. Any compatible client (television, hi-fi system, photo frame, mobile telephone, decoder unit, etc.) can retrieve items (video, music, photos) on a DLNA server. This server can be installed on a computer or mobile telephone, or be a standalone unit with a hard disk. The network links can be via Ethernet or Wi-Fi.

DLNA is based on a number of standards, including Wi-Fi, Ethernet and MoCA (en) for the physical layer, UPnP Device Architecture for discovery and control, UPnP AV for media management, HTTP for the transport layer, a wide range of audio, video and image format standards, and DTCP-IP for media protection during transport.

Universal Plug and Play (UPnP) is a network protocol promulgated by the UPnP Forum. The purpose of UPnP is to enable peripherals to easily connect and to simplify the implementation of home networks (file shares, communications, entertainment) and of corporate networks. UPnP makes this possible by defining and publishing the UPnP control protocols on top of the Internet's communication standards.

The UPnP architecture makes it possible to link personal computers, network devices and wireless peripherals in a peer-to-peer network. It is an open, distributed architecture based on the TCP/IP, UDP, and HTTP protocols. UPnP allows any two devices to communicate over the local network.

The UPnP architecture supports zero configuration, the “invisible network” and automatic discovery for several classes of peripherals. Each peripheral can dynamically join a network, obtain an address IP, announce its name, specify its capabilities on request and query the other peripherals as to their presence and capabilities. DHCP and DNS servers are optional and are only used if they are present on the network. The peripherals can disconnect from the network automatically without leaving any erroneous information.

UPnP AV (UPnP Audio and Video) is a group within the UPnP standard overseen by the DLNA.

As previously seen, preferably, the electronic device 16 utilizes a UPnP client/server Remote User Interface (RUI). In this way, it works as a UPnP client or server that can send commands over the network (such as save, program, play, pause, stop, etc.).

“Web4CE (CEA 2014) for UPnP Remote U11” or “CEA-2014” standard is a protocol based on web pages for the Remote User Interface of UPnP and Internet (Web4CE) networks. This standard makes it possible for a UPnP home network to provide its interface (display and controls) as a web page to display it on any connected peripheral. That is, peripherals on the home network can be controlled with any method of communication based on web browsing.

1-12. (canceled)

13. Method for communicating between terminals, that comprises:
a step of discovery between the terminals,
a step of broadcasting a televisual program by one of the terminals, called the “first” terminal,
a step of displaying, by said first terminal, an item of information representative of a first additional stream associated with said televisual program,
a step of transmitting, by the first terminal to a second terminal, an item of information representative of a second additional stream associated with said televisual program,
a step of accessing a remote application, by the second terminal, and
a step of displaying by said second terminal, within a user interface of said application, messages representative of the second additional stream.

14. Method according to claim 13, wherein during the transmission step, the item of information representative of the second additional stream is emitted over a multipoint network.

15. Method according to claim 13, that further comprises, after the step of displaying messages representative of the second additional stream in a user interface of the application, a step of taking control of the first terminal by a second terminal.

16. Method according to claim 13, wherein the second terminal utilizes a UPnP client/server Remote User Interface (RUI) to send commands over a network linking the first and the second terminal.

17. Method according to claim 13, that further comprises:
a step of broadcasting, by means of a system for broadcasting from one point to several points, said application comprising a server of pages described with a hypertext markup language,
a step of receiving said pages by the second terminal,
a step of accessing, by the second terminal, graphical resources and/or pointers to graphics resources linked to said pages, by means of an internet link of the second terminal, and
a step of synchronizing, by said application, audiovisual programs broadcast by the broadcast system and data accessed over the Internet by said second terminal.

18. Method according to claim 17, wherein:
during a signaling step, an application announces its presence on the network using UPnP/DLNA or Bonjour types of technologies and/or some other discovery protocol and/or
the second terminal discovers the page server by utilizing UPnP/DLNA or Bonjour types of technologies and/or some other discovery protocol.

19. Method according to claim 18, wherein the pages are described in HTML and the receiver comprises an HTML display unit.

20. Method according to claim 13, wherein, during an interaction step, at least one other device connected to the network interacts with the receiver, by means of a renderer function of the receiver.

21. Method according to claim 13, wherein, during an interaction step, at least one other device connected to the network interacts with the receiver, by means of a remote user interface's renderer function.

22. Device for communicating between terminals, that comprises:
a means of discovery between the terminals,
a means of broadcasting a televisual program by one of the terminals, called the “first” terminal,
a means of displaying, by said first terminal, an item of information representative of a first additional stream associated with said televisual program,
a means of transmitting, by the first terminal to a second terminal, an item of information representative of a second additional stream associated with said televisual program,
a means of access to a remote application, by the second terminal, and
a means of displaying by the said second terminal, in a user interface of said application, messages representative of the second additional stream.

23. Device according to claim 22, wherein the means of transmission emits the item of information representative of the second additional stream over a multipoint network.

24. Communications device according to claim 22, that comprises:
a means of broadcasting, by means of a multipoint network, an application comprising a server of pages described with a hypertext markup language,
a means of receiving and displaying said pages by the receiver,
a means of accessing graphical resources and/or pointers to graphics resources linked to said pages, by means of an internet link of the receiver, and
a means of synchronizing, by said application, audiovisual programs broadcast by the broadcast system and data accessed over the Internet by said second terminal.
